(19) United States
(12) Patent Application Publication
(10) Pub. No.: US 2020/0374984 A1
(43) Pub. Date: Nov. 26, 2020

(54) OHMIC HEATER AND METHOD FOR OPERATING

(71) Applicant: CFT S.P.A., 43122 PARMA (IT)

(72) Inventors: ROBERTO CATELLI, PARMA (IT); PAOLO COVA, PARMA (IT); STEFANO ROMEI, PARMA (IT); ALESSANDRO SOLDATI, LANGHIRANO (IT); GIOVANNI FRANCESCHINI, REGGIO NELL'EMILIA (IT); ANDREA TOSCANI, SALSOMAGGIORE TERME (IT)

(21) Appl. No.: 16/767,993

(22) PCT Filed: Dec. 4, 2018
(86) PCT No.: PCT/IB2018/059609

§ 371 Date: May 28, 2020

(30) Foreign Application Priority Data
Dec. 4, 2017 (IT) 102017000139860

(51) Int. Cl. H05B 1/02; H05B 3/00; H02M 5/458

(52) U.S. Cl. CPC H05B 1/0261; H02M 5/4585; H05B 3/0023

(57) ABSTRACT

An ohmic heater for heating a food product, comprising: —an inverter (3) comprising controlled switches (30); —a pair (4) of electrodes that can be positioned in contact with the food product to be heated, said inverter (3) being operatively interposed between a rectifier (2) of the supply voltage and the pair (4) of electrodes; —a transformer (6) located between the inverter (3) and the pair (4) of electrodes for regulating the amplitude of the voltage; —means (7) for determining the continuous component of the current in a zone downstream of the inverter (3) and upstream or at the transformer (6); —a system (800) for regulating the closing duration of the switches (30) of said inverter (3) that operates as a function of the means (7) for determining the continuous component by minimising/suppressing said continuous component.

### TECHNICAL FIELD

The present invention refers to an ohmic heater. It can be used to heat a food product.

### PRIOR ART

Ohmic heaters are known comprising:
a rectifier for rectifying three-phase supply voltage;
capacitors that level the output voltage from the rectifier;
an inverter which generates the desired waveform, located downstream of the capacitors;
a transformer located downstream of the inverter that multiplies the voltage in order to adapt it to the different conductivity of the product to be heated;
a bank of capacitors connected to each other in parallel and located upstream and in series to the transformer to protect it from overheating generated by a continuous component of the voltage (undesired, but unavoidable, consequence of the action of the inverter);
a pair of electrodes intended to come into contact with the product to be heated.

A drawback of this solution is linked to the row of capacitors connected to each other in parallel and in series and located upstream to the transformer, which require a significant footprint and a substantial investment for their purchase and maintenance.

A similar drawback is linked to the fact that the capacitors that level the output voltage from the rectifier are bulky, considering the powers involved (typically around 50-100 kW). Furthermore, electrolytic capacitors must be used, which have significant costs and above all could constitute a weak link in the reliability of the device (in terms of duration and required maintenance).

### AIM OF THE INVENTION

In this context, the technical task underpinning the present invention is to provide an ohmic heater and operating method which obviate the drawbacks of the prior art as cited above.

In particular, an object of the present invention is to provide an ohmic heater which allows the optimization of costs and sizes.

The technical task set and the objects specified are substantially attained by an ohmic heater and operating method, comprising the technical characteristics as set out in one or more of the accompanying claims.

### BRIEF DESCRIPTION OF THE DRAWINGS

Further characteristics and advantages of the present invention will become more apparent from the approximate and thus non-limiting description of a preferred, but not exclusive, embodiment of a heater, as illustrated in the accompanying drawings, in which:

FIG. 1 shows a schematic view of a heater according to the present invention;

FIG. 2 shows a voltage-time diagram indicating the waveform generated by the rectifier of the heater of FIG. 1;

FIG. 3a shows a voltage-time diagram indicating the waveform generated by the inverter of the heater of FIG. 1;

FIG. 3b shows a voltage-time diagram indicating the waveform generated by the transformer of the heater of FIG. 1;

FIG. 4 shows the path of the current in a first operating mode of the inverter of FIG. 1;

FIG. 5 shows the path of the current in a second operating mode of the inverter of FIG. 1.

### DETAILED DESCRIPTION OF PREFERRED EMBODIMENTS OF THE INVENTION

An ohmic heater is denoted in the appended figures by reference number 1. It is typically used to heat a food product.

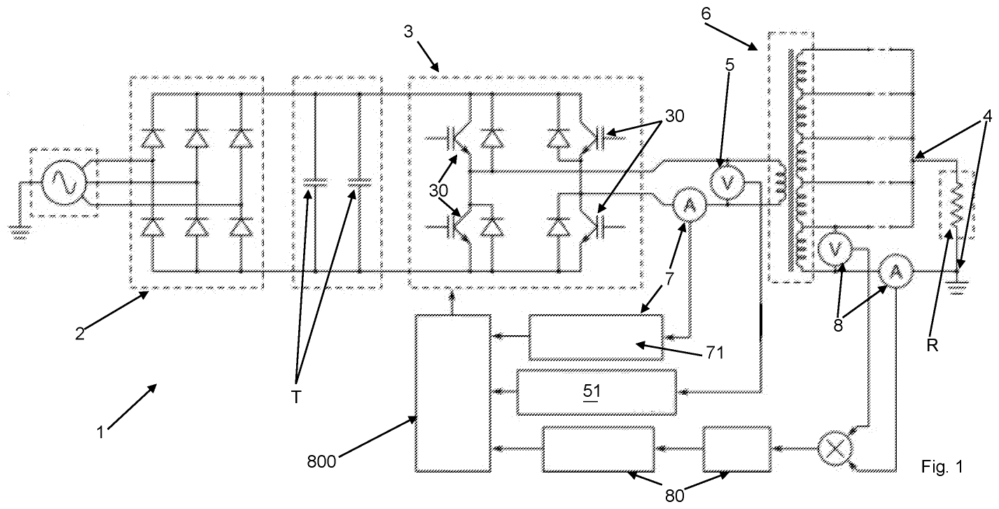

The ohmic heater 1 comprises a rectifier 2 of the supply voltage. It can for example comprise a diode bridge as shown in FIG. 1. More in detail in the solution of FIG. 1, the rectifier comprises 3 IXYS MDD 172/16 modules.

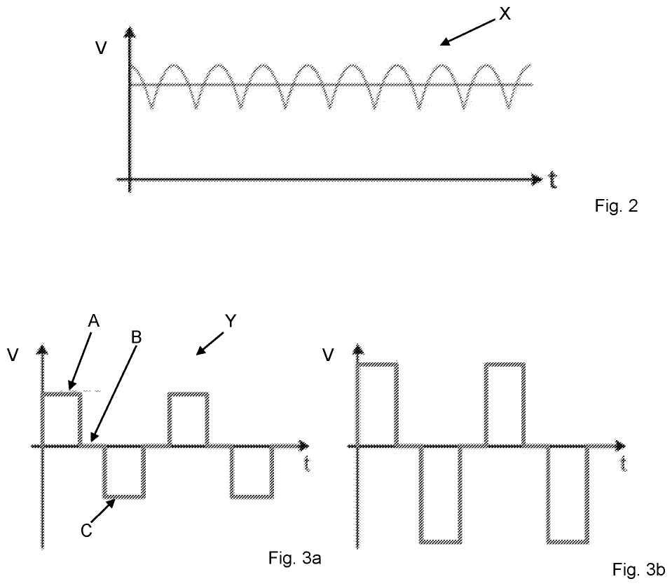

The supply voltage is alternating and the output voltage of the rectifier would ideally generate continuous voltage. In practice, for reasons relating to the structure of the rectifier 2, the voltage X that is generated is variable in time (see FIG. 2). A diagram that shows the time on the abscissa and the voltage on the ordinate draws many sinusoid arcs that are repeated identically. In the case of a three-phase diode bridge, the frequency of these arcs is equal to 300 Hz (if the supply voltage is equal to 50 Hz). The heater 1 further comprises an inverter 3 in turn comprising controlled switches 30. The term controlled switches is used to indicate that it is possible to intervene on the time instants and intervals of opening/closing the switches 30 in order to obtain the desired alternating waveform Y downstream (see FIG. 3a). Throughout the present description, it should be noted that the term closed switch is intended as a switch that allows the passage of current. On the contrary, the term open switch is intended as a switch that prevents the passage of current.

In the preferred embodiment (see for example FIG. 1) the inverter 3 is an H-bridge inverter. The switches 30 of the inverter 3 define the switches 30 of the H-bridge 3.

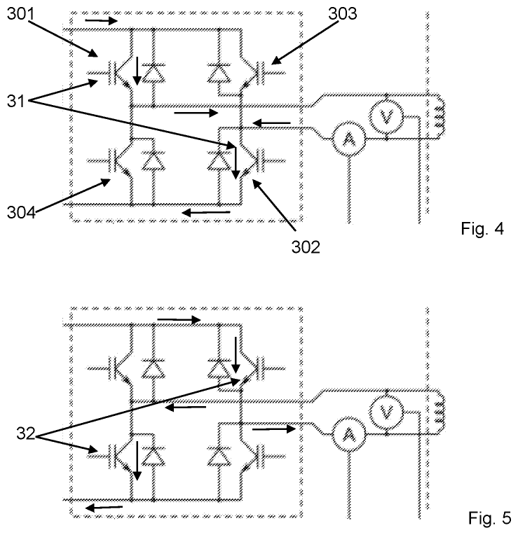

In particular, they define at least a first and a second pair 31, 32 of switches 30 which close alternately (causing the alternation of the first and second operating mode illustrated respectively in FIG. 4 and FIG. 5) generating an alternating wave Y downstream. The first pair 31 of switches 30 advantageously comprises a first and a second switch 301, 302. The second pair 32 of switches comprises a third and a fourth switch 303, 304. The first and third switch 301, 303 are the switches at the top of the H-bridge. They are also called “source” (or “high side switch”) in the technical field. The second and fourth switch 302, 304 are the switches at the bottom of the H-bridge. They are also called “sink” (or low side switch) in the technical field.

Unless the heater 1 operates in conditions of maximum power between the first and second operating mode described above, a time interval is envisaged wherein the first and third switch 301, 303 or the second and fourth switch 302, 304 are closed. In FIG. 3a:
the positive pulse indicated by reference letter A is associated with the closing of the first pair 31 of switches;
the portion with null voltage indicated by reference letter B is associated with the closing of the first and third switches 301, 303 or the second and fourth switches 302, 304;
the negative pulse indicated by reference letter C is associated with the closing of the second pair 32 of switches.

In the preferred embodiment, the inverter 3 is of the H-bridge IGBT type (Insulated Gate Bipolar Transistor), appropriately class 1200 V.

In the preferred embodiment the heater 1 comprises a pair 4 of electrodes which can be arranged in contact with the food product to be heated. The passage of current between the pair 4 of electrodes causes the passage of current in the product interposed between them, causing its heating by the Joule effect (this is the general peculiarity of ohmic heaters). The product that is heated has a fluid structure in which solid elements can also be dispersed.

The inverter 3 is operatively interposed between the rectifier 2 and the pair 4 of electrodes.

In a constructional solution shown in the appended figures, the heater 1 comprises means 5 for determining an oscillating voltage X generated by the rectifier 2. This is the voltage X which is located immediately downstream of the rectifier 2. It is the voltage that can be detected on the bus interposed between the rectifier 2 and inverter 3 (which is why it can also be defined bus voltage). The means 5 determines the voltage X shown in FIG. 2.

It can therefore measure the voltage X in a section between the rectifier 2 and the inverter 3. It could however also measure the voltage X in a section downstream of the inverter 3 from the moment that the envelope of the voltage-time wave Y downstream of the inverter 3 makes it however possible to determine (by means of the data processing system 51) the trend of the voltage X generated by the rectifier 2 (i.e. the voltage which is visible between the rectifier 2 and the inverter 3). The latter solution is that shown in FIG. 1.

In fact, the wave Y of alternating voltage generated by the inverter 3 has a frequency (in the preferred solution it assumes a value between 20000 and 40000 Hz, preferably 30000 Hz) that is at least 30 times greater than the frequency of said variable voltage X generated by the rectifier 2 (which is 300 Hz), as indicated previously.

The wave Y generated by the inverter 3 is substantially a square wave. It is bipolar.

The heater 1 further comprises a system 800 for regulating the closing duration of the switches 30 of the inverter 3.

Preferably but not necessarily, the system 800 for regulating can operate as a function of the corresponding voltage X determined at a given instant by the means 5 for determining an oscillating voltage X. The system 800 for regulating the closing duration of the switches of the inverter 3 makes it possible to regulate, instant-by-instant, the closing time of both the first and the second pair 31, 32 of switches 30. In particular the system 800 for regulating the closing duration of the switches 30 makes it possible to regulate the time instant wherein both the first and the second pair 31, 32 of switches open and the one in which they close.

The use of the means 5 for determining an oscillating voltage X is necessary in the absence of capacitors capable of levelling the output voltage X from the rectifier. The capacitors indicated with reference letter T in FIG. 1 make it possible to absorb sudden surges in voltage associated with the switching of the switches 30, but do not allow the levelling of the output voltage X from the rectifier 2.

The system 800 for regulating the closing duration of the switches 30:
as the voltage X generated by the rectifier 2 and detected by the means 5 for determining an oscillating voltage X decreases; and
with the other conditions being the same;
determines an increase in the duration of pulses (of non-null amplitude) in a wave Y of alternating voltage that determines the passage of an electric current between a pair 4 of electrodes located downstream of the inverter 3 and vice versa.

In particular, the system 800 determines an increase in the closing duration of the first and second pair 31, 32 of switches with a decrease in the voltage X generated by the rectifier 2 and detected by the detecting means 5. The system 800 for regulating the closing duration of the switches 30 similarly causes a reduction in the closing duration of the first and second pair 31, 32 of switches as the voltage X detected by the detecting means 5 increases. In other words, a perfectly levelled voltage X is not used in order to avoid large, expensive and delicate capacitors and therefore a pulse width modulation is performed on the voltage-time curve generated by the inverter 3 to compensate for the variability of the bus voltage X.

If the means 5 indicates that the bus voltage X (on the ordinate) increases, then the width of the pulse (on the abscissa) should be restricted and therefore the closing time of at least a part of the switches 30.

This occurs without changing the frequency of the wave Y of FIG. 3a. This is achieved by accordingly regulating the duration of the interval wherein all the switches 30 determine the space B at null voltage indicated in FIG. 3a.

If the means 5 indicate that the bus voltage X (on the ordinate) decreases, then the width of the pulse (on the abscissa) should increase and therefore the closing time of at least a part of the switches 30.

The regulation of the closing duration of the switches 30 therefore makes it possible to keep the delivered power constant in time as a function of the signal coming from the means 5 for determining an oscillating voltage X.

This makes it possible to properly heat the product that passes between the pair 4 of electrodes.

In an alternative solution which is not illustrated, a large bank of capacitors could be present which is capable of levelling the voltage X generated by the rectifier 2. In this case the means 5 for determining an oscillating voltage X generated by the rectifier 2 could be superfluous.

The heater 1 comprises a transformer 6 located between the inverter 3 and the pair 4 of electrodes for regulating the amplitude of the voltage. This makes it possible to adapt the voltage as a function of the resistivity of the product to be heated. When the resistivity is low, it is necessary to amplify the voltage value more than when the resistivity of the product is low.

Characteristically, the heater 1 comprises means 7 for determining the continuous component of the current in a zone downstream of the inverter 3 and upstream or at the transformer 6. The means 7 for determining the continuous component as such is known and in the preferred embodiment comprises a Hall-effect current transducer. The means 7 for determining the continuous component comprises a data processing unit 71 that processes the measured current in order to be able to extract the value of the continuous component in a known manner. This continuous component is an undesired consequence of the fact that there may be minimal asymmetries in the components of the inverter 3 (due to the fact that this is a real device and not an ideal one). The transformer 6 is very sensitive to this continuous component, which even with small values is capable of damaging it. There are devices to minimize the sensitivity of the transformer 6 to such a continuous component, but they penalize efficiency and are therefore to be avoided.

On this point, the system 800 for (instant-by-instant) regulation of the closing duration of the switches 30 of said inverter 3 operates in order to minimize or best nullify the signal coming from the means 7 for determining the continuous component. The system can then act in feedback.

The system 800 for regulating the closing duration intervenes on the waveform Y and in particular intervenes instant-by-instant:
on the width of the positive pulses of the waveform Y (which lie above the axis of abscissas); or
on the width of the negative pulses of the waveform Y (which lie below the axis of abscissas).

In particular the system 800 for regulating the closing duration intervenes to modify the mean value of such wave Y.

The elimination of bulky capacitors makes it possible to considerably reduce the size of the heater 1.

In the preferred embodiment the rectifier 2, the inverter 3 and the transformer can be placed in a parallelepiped casing having the size 300×300×800 mm.

Advantageously the heater 1 comprises a cooling plate provided with a coil wherein a cooling fluid circulates. It allows the cooling of power electronic components. Preferably this cooling plate is made of aluminium. Appropriately the coil passes under the inverter 3 and the rectifier 2.

An operating method of an ohmic heater 1 also constitutes a subject matter of the present invention. It is advantageously implemented by an ohmic heater 1 having one or more of the characteristics described in the foregoing.

Usually the supply voltage will be alternating. It is therefore envisaged to rectify an alternating supply voltage by means of a rectifier 2. Advantageously the rectifier 2 is a three-phase diode type. It generates a variable voltage X in time (the bus voltage described above). As indicated above, a diagram that shows the time on the abscissa and the voltage X on the ordinate draws many sinusoid arcs that are repeated identically (with a frequency of 300 Hz if the supply voltage is 50 Hz). This diagram is illustrated in FIG. 2.

The method can further comprise the step of measuring said variable voltage X in time (generated by the rectifier 2; it is therefore the voltage which is located immediately downstream of the rectifier 2). In fact, if the voltage X is not levelled, it will be important to take account of such unevenness to still be able to exploit it in the best of ways. This is the preferred solution to which the accompanying figures refer.

The method comprises the step of regulating the closing time of the switches 30 forming part of an inverter 3. This can advantageously be used to compensate the oscillations of said variable voltage variable X (the bus voltage) in time. As previously explained, in the preferred embodiment this inverter 3 is an inverter 3 comprising an H-bridge.

A value lower than the variable voltage X (generated by the rectifier 2) is associated with a greater closing time of at least a part of the switches 30 generating a wave Y of alternating voltage.

This wave Y, possibly amplified at will, determines the passage of an electric current between at least one pair 4 of electrodes located downstream of the inverter 3. In this way the electric current passes through the product present between the electrodes 4, heating it by the Joule effect. The step of amplifying or reducing the amplitude of the voltage preferably takes place through a transformer 6 located downstream of the inverter 3 and upstream of the pair 4 of electrodes.

The waveform Y of the alternating voltage generated by the inverter 3 has a frequency that is at least 30 times greater (preferably at least 90 times greater) than the frequency of said variable voltage X generated by the rectifier 2.

The step of regulating the closing time of the switches 30 envisages compensating for a reduction/increase in the variable voltage X delivered by the rectifier 2 (and measured by the means 5) respectively with a longer/shorter closing duration of a part of said switches 30. Because of the significant difference in frequency between the wave Y generated by the inverter 3 and that by the rectifier 2, during the time interval wherein a pair of switches remains closed, the voltage X generated by the rectifier 2 is not changed in a significant manner.

The step of regulating the closing time of the switches 30 envisages varying the area under the profile of said wave Y in a Cartesian diagram having voltage on the ordinate and time on the abscissa such that the power delivered by the ohmic heater 1 remains in line with what is desired. In the embodiment exemplified in FIGS. 4 and 5 the diode inverter 3 comprises a first and a second pair 31, 32 of switches (transistor). The positive pulses of the voltage wave Y (see FIG. 3a) are associated with the closing of the first pair 31 of switches and the opening of the second pair 32 of switches (see FIG. 4). The negative pulses of the voltage wave Y are associated with the opening of the first pair 31 of switches and the closing of the second pair 32 of switches.

In an alternative embodiment not shown, the voltage X generated by the rectifier 2 could be levelled through the use of important capacitors located immediately downstream of the rectifier 2. In this case it is not necessary to control the closing of the switches 30 as a function of the variable voltage X immediately downstream of the rectifier 2 (bus voltage). In fact in this case, the bus voltage is constant and therefore such control is superfluous.

Characteristically the method comprises the step of determining the continuous component of the electric current entering the transformer 6.

In fact, the step of regulating the closing time of the switches 30 which are part of the inverter 3 advantageously takes place as a function of the continuous component of the determined electric current entering the transformer 6. The purpose of this control is in fact to suppress/reduce the continuous component. As previously explained, this continuous component is in fact deleterious to the transformer 6.

The step of suppressing/reducing the continuous component envisages regulating the closing time of the switches 30 in order to vary the width of a plurality of positive pulses or alternatively of a plurality of negative pulses of said wave Y of alternating voltage. By modifying the width of the positive pulses (without also modifying the width of the negative pulses or modifying it in the opposite direction), the average value of the wave Y changes. Similarly, it changes by modifying the width of the negative pulses (without also modifying the width of the positive pulses or modifying it in the opposite direction). This therefore provides compensation, suppressing or significantly reducing the continuous component entering the transformer 6.

Consequently if at the input of the transformer 6 a continuous component of the current is measured with a positive sign, the method envisages increasing the width of the negative pulses of the wave Y, while leaving unaltered the width of the positive pulses of the wave Y. Alternatively, it is possible to reduce the width of the positive pulses of the wave Y while leaving unaltered the width of the negative pulses of the wave Y.

Similarly if at the input of the transformer 6 a continuous component of the current is measured with a negative sign, the method envisages increasing the width of the positive pulses while leaving unaltered the width of the negative pulses of the wave Y. Alternatively it is possible to reduce the width of the negative pulses, leaving unaltered the width of the positive pulses.

The step of suppressing/reducing the continuous component envisages regulating the closing time of the switches 30 to modify the average value of the wave Y generated by the inverter 3 in order to compensate the continuous component of the measured current entering the transformer 6. The frequency with which such modification takes place is preferably comprised between 20000 Hz and 40000 Hz.

The modification of the width of these pulses is regardless contained, and therefore does not generate variations which can significantly alter the overall power delivered by the heater 1.

A further control, which however is much slower compared to the control of the continuous component and the (optional) control of the variation of the bus voltage X, is linked to the power of the heater 1. In order to monitor the power, the method envisages measuring the current and the voltage on the load (on the pair of electrodes 4). In FIG. 1 this measurement is performed by the sensors indicated by reference number 8. This data is then filtered and processed by the means 80.

Depending on the power required, the method then envisages widening the width of the positive and negative pulses. The regulation resulting from the control of the continuous component, and if present, also that of the bus voltage, is added to this first regulation. In this respect the control of the continuous component of the electric current entering the transformer 6 will determine a coefficient which will have to be multiplied by the width of the pulses required by the power so as to correct the actual width of the pulses. The control of the amplitude of the pulses related to the variability of the bus voltage is similar.

The present invention achieves important advantages.

Firstly, it makes it possible to avoid the use of large capacitors which have significant purchase and maintenance costs. Furthermore, they have a significant footprint that is reflected on the dimensions of the heater 1.

The invention as it is conceived is susceptible to numerous modifications and variations, all falling within the scope of the inventive concept characterising it. Furthermore, all the details can be replaced with other technically-equivalent elements. In practice, all the materials used, as well as the dimensions, can be any according to requirements.

1. A method for operating an ohmic heater, comprising the steps of:
rectifying an alternating supply voltage by means of a rectifier (2);
regulating the closing time of switches (30) being part of an inverter (3) generating a wave (Y) of alternating voltage that determines the passage of an electric current between a pair (4) of electrodes located downstream of the inverter (3);
varying the amplitude of the wave (Y) by means of a transformer (6) located downstream of the inverter (3) and upstream of the pair (4) of electrodes;
characterised in that it comprises the step of determining the continuous component of the electric current entering the transformer (6);
the step of regulating the closing time of the switches (30) being part of the inverter (3) taking place as a function of the continuous component of the electric current entering the transformer (6) so as to suppress/reduce such continuous component.

2. The method according to claim 1, characterised in that the step of suppressing/reducing the continuous component envisages regulating the closing time of the switches (30) in order to vary the width of a plurality of positive pulses or alternatively of a plurality of negative pulses of said wave (Y) of alternating voltage.

3. The method according to claim 2 characterised by:
increasing the width of the negative pulses of the wave (Y) while leaving unaltered the width of the positive pulses of the wave (Y); or
reducing the width of the positive pulses of the wave (Y) while leaving unaltered the width of the negative pulses of the wave (Y);
if at the inlet to the transformer (6) a continuous component of the current with a positive sign is noted.

4. The method according to claim 2, characterised by:
increasing the width of the positive pulses of the wave (Y) while leaving unaltered the width of the negative pulses of the wave (Y);
reducing the width of the negative pulses of the wave (Y) while leaving unaltered the width of the positive pulses of the wave (Y);
if at the inlet to the transformer (6) a continuous component of the current with a negative sign is noted.

5. The method according to claim 1, characterised in that said rectifier (2) generates a voltage that is variable over time; the wave (Y) of alternating voltage generated by the inverter (3) has a frequency that is at least 30 times higher than the frequency of a variable voltage (X) generated by the rectifier (2).

6. The method according to claim 5, characterised in that it comprises a step of measuring said variable voltage (X) over time; the step of regulating the closing time of the switches (30) being part of the inverter (3) comprises the step of compensating over time for the oscillations of said variable voltage (X), a longer closing time of at least a part of the switches (30) being associated with a lower variable voltage (X) value.

7. The method according to claim 6, characterised in that the step of regulating the closing time of the switches (30) envisages compensating for a reduction/increase in variable voltage (X) measured with a longer/shorter duration, respectively, of the closing of a part of said switches (30).

8. An ohmic heater for heating a food product, comprising:
an inverter (3) comprising controlled switches (30);
a rectifier (2) for rectifying the supply voltage;
a pair (4) of electrodes that can be positioned in contact with the food product to be heated, said inverter (3) being operatively interposed between the rectifier (2) and the pair (4) of electrodes;
a transformer (6) located between the inverter (3) and the pair (4) of electrodes for regulating the amplitude of the voltage;
characterised in that it comprises:
means (7) for determining the continuous component of the current in a zone downstream of the inverter (3) and upstream or at an inlet of the transformer (6);
a system (800) for regulating the closing duration of the switches (30) of said inverter (3) that operates as a function of the means (7) for determining the continuous component by minimising/suppressing said continuous component.

9. The heater according to claim 8, characterised in that the inverter (3) is an H-bridge inverter and the switches (30) of the H-bridge (3) define at least a first and a second pair (31, 32) of switches (30) and close alternatively generating an alternating voltage (Y) downstream.

10. The heater according to claim 8, characterised in that it comprises:
a rectifier (2) for rectifying a supply voltage;
means (5) for determining an oscillating voltage generated by the rectifier (2); a system (800) for regulating the closing duration of the switches (30) of the inverter (2) at least as a function of the corresponding voltage (X) determined at a given time instant by the means (5) for determining an oscillating voltage X; the system (800) for regulating the closing duration of the switches (30) determining an increase of such duration as the voltage (X) determined by the means (5) for determining an oscillating voltage X is reduced, and vice versa.
